(19) United States
(12) Patent Application Publication
(10) Pub. No.: US 2026/0184329 A1
(43) Pub. Date: Jul. 2, 2026

(54) METHOD OF MONITORING DRIVER

(71) Applicant: MiTAC Digital Technology Corporation, Taoyuan City (TW)

(72) Inventor: Hsiang-Yu HSIEH, Taoyuan City (TW)

(21) Appl. No.: 19/436,679

(22) Filed: Dec. 30, 2025

(30) Foreign Application Priority Data
Jan. 2, 2025 (TW) 114100162
Jun. 13, 2025 (TW) 114122203

(51) Int. Cl. B60W 50/14; B60W 40/08; G06V 10/60; G06V 10/80; G06V 10/98; G06V 20/59; G06V 40/16

(52) U.S. Cl. CPC B60W 50/14; B60W 40/08; G06V 10/60; G06V 10/806; G06V 10/993; G06V 20/597; G06V 40/161; G06V 40/171; B60W 2040/0818; B60W 2420/403; B60W 2520/105; B60W 2540/223; B60W 2540/229

(57) ABSTRACT

A method of monitoring a driver is to be implemented by an in-vehicle monitoring device that includes an image capturing unit, a driver monitoring unit, and a processing unit electrically connected to the image capturing unit and the driver monitoring unit. The method includes steps, to be implemented by the processing unit, of: in response to receiving an alert event from the driver monitoring unit, obtaining from the image capturing unit a to-be-analyzed image related to the alert event; calculating a similarity value indicating similarity between the to-be-analyzed image and a standard image; determining whether the similarity value is greater than a similarity threshold value; and in response to determining that the similarity value is greater than the similarity threshold value, controlling the driver monitoring unit to not output an alert signal related to the alert event.

### CROSS-REFERENCE TO RELATED APPLICATION

This application claims priority to Taiwanese Invention Patent Application No. 114122203, filed on Jun. 13, 2025, and Taiwanese Invention Patent Application No. 114100162, filed on Jan. 2, 2025, the entire disclosure of which is incorporated by reference herein.

### FIELD

The disclosure relates to a monitoring method, and more particularly to a method of monitoring a driver.

### BACKGROUND

A conventional in-vehicle driver monitoring system uses a camera fixedly mounted inside a vehicle to capture multiple images of a driver, and uses facial recognition technology to extract facial features so as to determine head angles of the driver to determine whether the driver is distracted or fatigued. Generally speaking, in-vehicle driver monitoring systems consider large changes in head angles from side to side as a state of distraction, and large changes in head pitch as a state of fatigue. When the pitch angle or left and right angle of the driver's head posture is greater than a preset threshold value, the in-vehicle driver monitoring system determines that the driver is in a state of fatigue or distracted driving.

Although existing technologies can use images to identify changes in the driver's body frame to determine whether the driver has changed their posture, in cases where the cabin of the vehicle is too small, the distance between the camera and the driver is relatively short, making it difficult to capture the driver's complete body frame movement and accurately determine whether the driver has changed their posture. Moreover, when driving the vehicle on the road, the driver's head posture as captured by the camera may shift due to bumps in the road or changes in the driver's driving posture or position, which could be determined as an excessive head rotation and trigger the driver monitoring system, causing the emergency notification system of the driver monitoring system to be frequently triggered.

### SUMMARY

Therefore, an object of the disclosure is to provide a method of monitoring a driver that can alleviate at least one of the drawbacks of the prior art.

According to the disclosure, the method is to be implemented by an in-vehicle monitoring device that includes an image capturing unit for capturing an image of the driver, a driver monitoring unit for generating an alert event in response to determining that the driver is fatigued or distracted, and a processing unit electrically connected to the image capturing unit and the driver monitoring unit. The method includes steps, to be implemented by the processing unit, of: in response to receiving the alert event from the driver monitoring unit, obtaining from the image capturing unit a to-be-analyzed image related to the alert event; calculating a similarity value indicating similarity between the to-be-analyzed image and a standard image, the standard image indicating a typical driving posture of the driver and being obtained by the processing unit based on a plurality of reference image frames that were captured by the image capturing unit prior to the to-be-analyzed image; determining whether the similarity value is greater than a similarity threshold value; and in response to determining that the similarity value is greater than the similarity threshold value, controlling the driver monitoring unit to not output an alert signal related to the alert event.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an in-vehicle driver monitoring system for implementing a method of monitoring a driver according to an embodiment of the disclosure.

FIG. 2 is a flow chart of the method of monitoring a driver according to an embodiment of the disclosure.

FIG. 3 is a flow chart illustrating sub-steps of obtaining a standard image according to an embodiment of the disclosure.

FIG. 4 is a flow chart illustrating sub-steps of obtaining a plurality of normalized reference images according to an embodiment of the disclosure.

FIG. 5 is a flow chart illustrating sub-steps of calculating a similarity value according to an embodiment of the disclosure.

FIG. 6 is a flow chart illustrating sub-steps of obtaining a normalized to-be-analyzed image according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

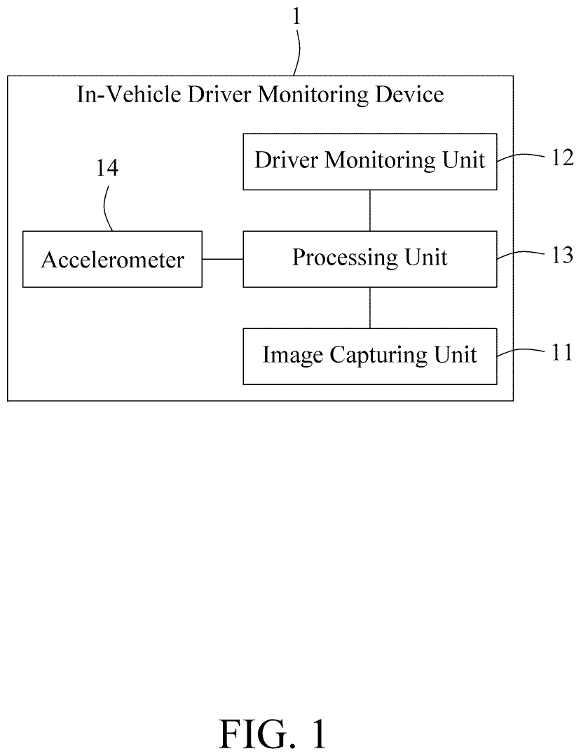

Referring to FIG. 1, an in-vehicle driver monitoring device 1 configured to implement a method of monitoring a driver of a vehicle is provided according to an embodiment. The in-vehicle driver monitoring device 1 is installed on the vehicle, and includes an image capturing unit 11 for continuously capturing images of the driver, a driver monitoring unit 12 for generating an alert event in response to determining that the driver is fatigued or distracted, and a processing unit 13 electrically connected to the image capturing unit 11 and the driver monitoring unit 12.

In some embodiments, the image capturing unit 11 and the driver monitoring unit 12 may be embodied as a driver monitoring system (DMS). Specifically, the image capturing unit 11 may be implemented by a driver-facing camera of the DMS. The processing unit 13 may be a central processing unit (CPU) or any equivalents.

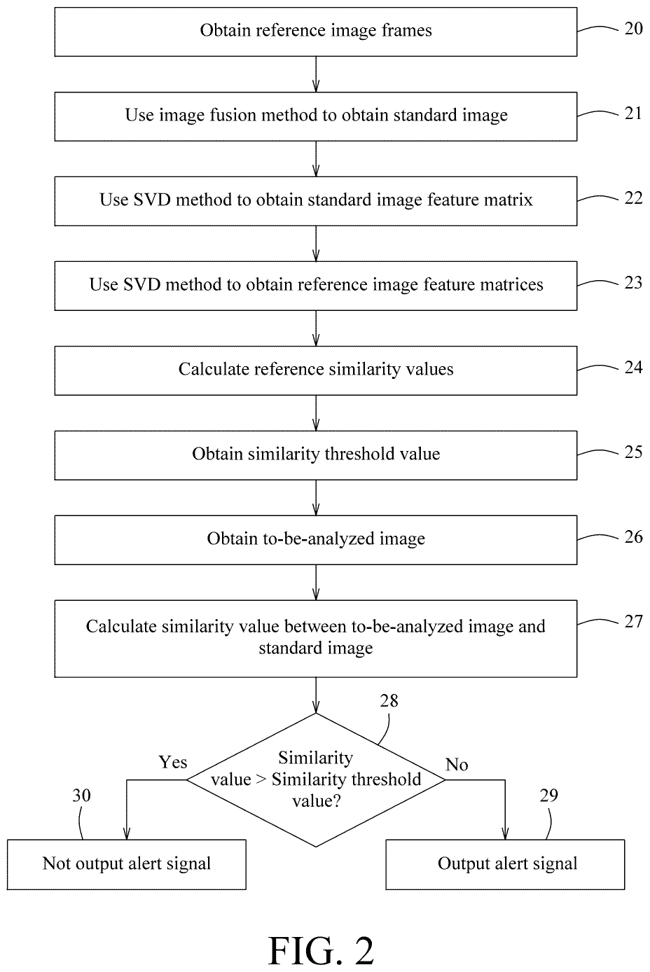

Referring to FIG. 2, the method of monitoring a driver according to an embodiment of the disclosure includes the following steps.

In step 20, the processing unit 13 obtains a plurality of reference image-frames from the image capturing unit 11. In one embodiment, a quantity of the reference image frames to be obtained by the processing unit 13 is 50. In another embodiment, the quantity of the reference image frames to be obtained is 30. In still another embodiment, the quantity of the reference image frames to be obtained is 70. However, the disclosure is not limited to these quantities.

It should be noted that the term “image(s)” as used hereinafter refers to “image frame(s)”.

It is worth noting that the purpose of collecting multiple reference image frames is to improve accuracy of a standard image feature matrix that will be obtained in subsequent step 22 based on the plurality of reference image frames. A face region (i.e., portion containing a face) may not always be accurately detected from an image frame. Since quality of the image frame affects whether facial features can be successfully detected from the image frame, if image resolution is relatively low, the facial features may not be successfully detected, so additional image frames may need to be obtained to overcome this issue. Therefore, obtaining multiple reference image frames may improve error tolerance and thus improve the accuracy of the standard image feature matrix.

It should be noted that in some embodiments, the processing unit 13 may also automatically calculate and adjust, based on changes in light intensity of a current driving environment, the quantity of the reference image frames to be obtained. Specifically, the processing unit 13 may determine the light intensity of the current driving environment and determine whether the light intensity is within an optimal light intensity range. The processing unit 13 determines the light intensity of the current driving environment by, for example, analyzing data related to brightness of the reference image frames. The light intensity of the current driving environment may also be determined by, for example, using an ambient light sensor (not shown) that may be further included in the in-vehicle driver monitoring device 1 to detect lighting conditions (i.e., illuminance) in the current driving environment, and transmit data related to the detected lighting conditions to the processing unit 13 for the processing unit 13 to analyze and determine the light intensity therefrom.

The optimal light intensity range is a predetermined range and may be set based on practical needs. In some embodiments, the optimal light intensity range is from 100 Lux to 40,000 Lux. An illuminance below 100 Lux may indicate insufficient light intensity. An illuminance above 40,000 Lux may indicate over-illumination.

The following uses an example where an ambient light sensor is used to determine the light intensity of the current driving environment, and the quantity of the reference image frames to be obtained is, for example, 50. In such a case, the processing unit 13 may obtain light intensity values detected by the ambient light sensor during a time period in which, for example, 30 initial image frames of the reference image frames are captured. The processing unit 13 then calculates a percentage of the total quantity of the light intensity values detected during the time period that are within the optimal light intensity range. The percentage serves as an image quality value of the initial images frames. In a case where the image quality value is within an image quality range, for example, from 70% to 85%, the processing unit 13 may maintain the quantity of the reference image frames to be obtained, for example, at 50 (original quantity). If the image quality value is lower than the image quality range, for example, less than 70%, the processing unit 13 may increase the quantity of the reference image frames to be obtained, for example, from 50 (original quantity) to 70. In a case where the image quality value is above the image quality range, for example, above 85%, the processing unit 13 may decrease the quantity of the reference image frames to be obtained, for example, from 50 (original quantity) to 30. However, the disclosure is not limited in these respects.

That is, the processing unit 13 may automatically and dynamically adjust the quantity of the reference image frames to be obtained based on the current driving environment. While ensuring that there is sufficient data from the reference image frames to accurately detect the face region in subsequent steps in order to construct the standard image feature matrix with relatively higher accuracy, and at the same time taking into consideration how the quantity of the reference image frames may affect workload on the processing unit 13 (i.e., the higher the quantity of the reference image frames, the higher the workload on the processing unit 13), the processing unit 13 may automatically decrease the quantity of the reference image frames to be obtained when it is determined that the light intensity of the current driving environment is sufficient (i.e., within the optimal light intensity range), so as to reduce computational load on the processing unit 13. However, the disclosure is not limited thereto.

In some embodiments, the processing unit 13 may determine the quantity of the reference image frames to be obtained based on average brightness distribution and overall average brightness values of the reference image frames. The processing unit 13 obtains a plurality of initial image frames from the image capturing unit 11, and obtains an image quality value based on average brightness distribution and an overall average brightness value of each of the initial image frames. A quantity of the initial image frames obtained may be, for example, 30. The image quality value of the initial image frames is obtained as follows.

To determine the average brightness distribution, for each of the initial image frames, the processing unit 13 divides the initial image frame into four image regions (e.g., upper left region, lower left region, upper right region and lower right region). The processing unit 13 calculates an average brightness value for each of the four image regions, selects any one of the four image regions to serve as a reference region, and makes the average brightness value of the reference region serve as a reference brightness value. Then, for each of the three remaining image regions (i.e., the image regions except the reference region), the processing unit 13 compares the reference brightness value with the average brightness values of the remaining image region to obtain an absolute value of a difference between the average brightness value of the remaining image region and the reference brightness value. For example, in a case where the upper left region is selected to serve as the reference region, the three average brightness values respectively of the lower left region, the upper right region and the lower right region are each subtracted from the reference brightness value (i.e., the average brightness value of the upper left region) so as to obtain three differences, and three absolute values respectively of the differences are obtained. The processing unit 13 makes a largest one of the three absolute values serve as a maximum absolute value.

In addition, for each of the initial image frames, the processing unit 13 obtains the overall average brightness value based on the average brightness values of the four image regions. Since calculations of overall average brightness values are well-known to those skilled in the art, details thereof are omitted herein for the sake of brevity.

Then, to obtain the image quality value of the initial image frames, for each of the initial image frames, the processing unit 13 determines whether the maximum absolute value is greater than a difference threshold value (e.g., 10) and whether the overall average brightness value is within an average brightness optimal range (e.g., 70-85). The difference threshold value and the average brightness optimal range are predetermined values that may be set based on practical needs. In response to determining that the maximum absolute value is not greater than the difference threshold value and the overall average brightness value is within the average brightness optimal range, the processing unit 13 determines that the initial image frame is a high-quality image frame (i.e., an image frame with good quality); otherwise, the processing unit 13 determines that the initial image frame is a low-quality image frame. The processing unit 13 then calculates a quantity of the high-quality image frame(s) among the initial image frames, calculates a percentage of the total quantity of the initial image frames that are the high-quality image frame(s), and makes the percentage thus calculated serve as the image quality value.

If the image quality value is lower than or within an image quality range, for example, less than 70%, or from 70% to 85%, the processing unit 13 obtains a plurality of additional image frames from the image capturing unit 11. In a case where the image quality value is lower than the image quality range, for example, 70%, a quantity of the additional image frames may be, for example, 40. In a case where the image quality value is within the image quality range, for example, from 70% to 85%, the quantity of the additional image frames may be, for example, 20. The processing unit 13 then makes the initial image frames (e.g., the 30 initial image frames) and the additional image frames (e.g., 40 or 20) together serve as the plurality of reference image frames. Thus, in such a case, the quantity of the reference image frames may be, for example, 70 or 50, respectively for the aforementioned two exemplary image quality values. In a case where the image quality value is above the image quality range, for example, above 85%, the processing unit 13 may determine that the initial image frames are sufficient and makes the initial image frames serve as the plurality of reference image frames, in which case the quantity of the reference image frames remains as, for example, 30. However, the disclosure is not limited in these respects.

In other words, a greater difference between the average brightness values of the initial image frames may indicate a greater fluctuation in the light intensity of the current driving environment in which the initial image frames were captured; and an overall average brightness value of the initial image frames that falls outside of the average brightness optimal range may indicate excessive brightness or darkness of the initial image frames. Therefore, the quantity of the reference image frames may need to be increased accordingly to improve chances of obtaining details from the reference image frames. Conversely, a smaller difference between the average brightness values of the initial image frames may indicate relatively more stability in the light intensity of the current driving environment in which the initial image frames were captured; and an overall average brightness value of the initial image frames that is within the average brightness optimal range may indicate optimal brightness level of the initial image frames. Therefore, the quantity of the reference image frames may be reduced accordingly to reduce computational load on the processing unit 13. However, the disclosure is not limited to the above.

In step 21, the processing unit 13 uses an image fusion method to obtain a standard image based on the reference image frames. The standard image indicates a normal driving posture of the driver.

It should be noted that in the present embodiment, the processing unit 13 obtains the reference image frames captured by the image capturing unit 11 during each preset interval of time (e.g., 2 minutes), uses the image fusion method to obtain a new standard image based the reference image frames that were captured within the current interval of time, and uses the new standard image to replace a last standard image that was obtained based on the reference image frames captured within the last interval of time. Thereby, the standard image is updated in real time according to changes in the driver's driving posture.

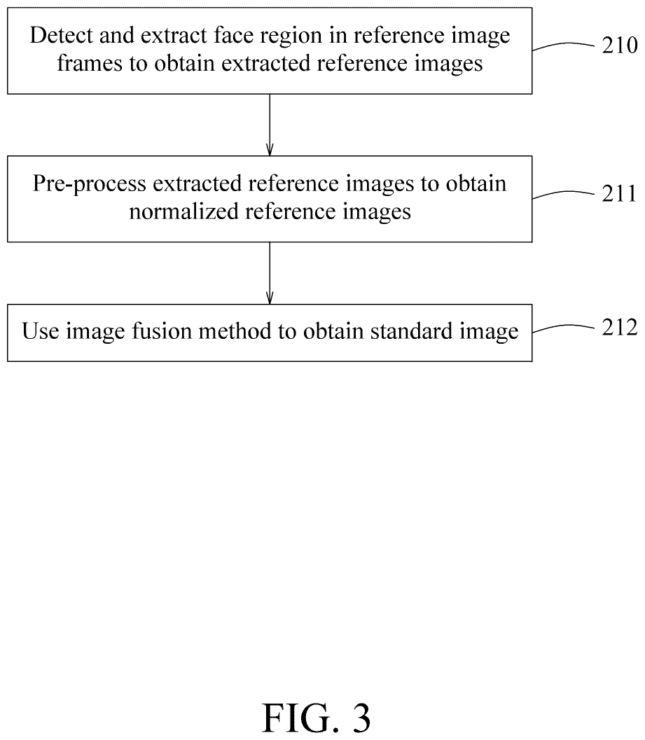

Referring to FIG. 3, step 21 includes sub-steps 210-212 described below.

In sub-step 210, for each of the reference image frames, the processing unit 13 detects and extracts a face region in the reference image frame to obtain an extracted reference image.

In sub-step 211, the processing unit 13 pre-processes the extracted reference images respectively from the reference image frames, so as to obtain a plurality of normalized reference images respectively based on the extracted reference images.

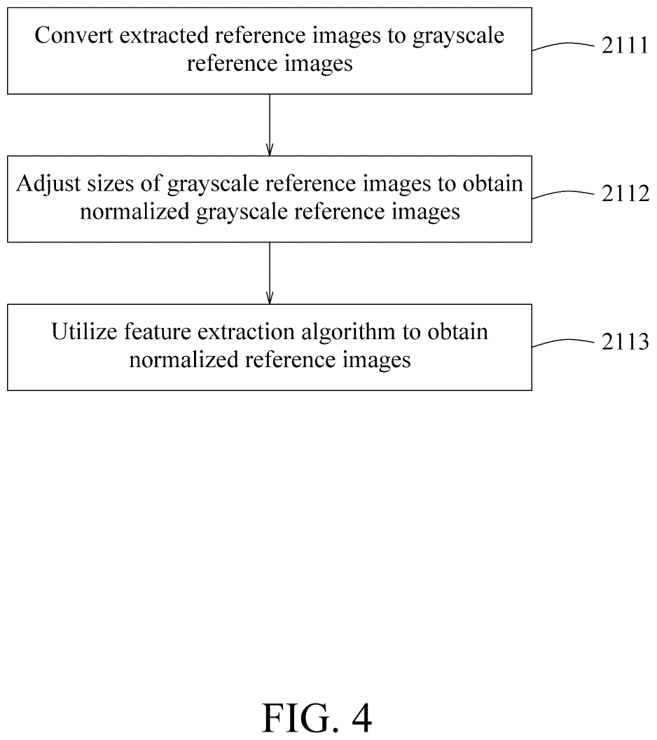

Sub-step 211 further includes sub-steps 2111-2113 (see FIG. 4) described below.

In sub-step 2111, the processing unit 13 converts the extracted reference images obtained in sub-step 210 to a plurality of grayscale reference images, respectively.

In sub-step 2112, the processing unit 13 adjusts a size of each of the grayscale reference images to obtain a plurality of normalized grayscale reference images with the same size, respectively from the grayscale reference images. In the present embodiment, each of the normalized grayscale reference images has a resolution of 64×96 pixels, but the disclosure is not limited thereto.

In sub-step 2113, to reduce the impact of data noise on the normalized grayscale reference images, the processing unit 13 utilizes a feature extraction algorithm to obtain the normalized reference images respectively based on the normalized grayscale reference images. More specifically, this sub-step is performed to remove irrelevant high-frequency signals in the centers of the normalized grayscale reference images, reducing computational load on and ensuring faster processing by the processing unit 13. It is worth noting that each of the normalized reference images includes a plurality of facial features in the corresponding one of the normalized grayscale reference image. In the present embodiment, the feature extraction algorithm may be, for example, a 3×3 convolution algorithm, but is not limited thereto.

In sub-step 212, the processing unit 13 uses the image fusion method to process the normalized reference images, so as to obtain the standard image. In the present embodiment, to generate each pixel value of the standard image, the image fusion method utilizes the following formula:

$${F}_{blend} ( x , y ) = \frac{1}{n} {\sum }_{i = 1}^{n} {Img}_{i} ( x , y )$$

where F_{blend}(x,y) represents a pixel value of each pixel located at an image array coordinate (x,y) in the standard image, n represents a quantity of the normalized reference images, and Imgᵢ(x,y) represents the pixel value of each pixel located at the image array coordinate (x,y) in an i-th one of the normalized reference images.

In step 22, the processing unit 13 uses a singular value decomposition (SVD) method to decompose an image data matrix of the standard image into the standard image feature matrix including a plurality of singular values of the standard image. It should be noted that using the SVD method to decompose the image data matrix of the standard image, which is a complex image data matrix, into a combination of two vector matrices, U and V, and a diagonal matrix 7 for representing important features of the standard image is a well-known practice, and thus details thereof are omitted herein for the sake of brevity.

In step 23, for each of the normalized reference images, the processing unit 13 uses the SVD method to decompose an image data matrix of the normalized reference image into a reference image feature matrix including a plurality of singular values of the normalized reference image.

In step 24, for each of the reference image feature matrices obtained respectively from the normalized reference images in step 23, the processing unit 13 calculates a reference similarity value based on the standard image feature matrix and the reference image feature matrix. In the present embodiment, the reference similarity value is a reference geometric distance obtained by calculating the Euclidean distance between the reference image feature matrix and the standard image feature matrix, but the disclosure is not limited thereto. That is, a larger Euclidean distance indicates a lower similarity between the reference image feature matrix and the standard image feature matrix (i.e., a lower similarity between the reference image and the standard image).

In step 25, the processing unit 13 obtains a similarity threshold value based on the reference similarity values that are obtained respectively for the reference image feature matrices in step 24. In the present embodiment, the similarity threshold value is a reference geometric distance threshold value. Specifically, the processing unit 13 calculates an average and a standard deviation of the reference geometric distances (i.e., the reference similarity values). The processing unit 13 then calculates the reference geometric distance threshold value (i.e., the similarity threshold value) as the sum of the average and the standard deviation of the reference geometric distances, but the disclosure is not limited thereto.

It should be noted that steps 23-25 are not necessarily executed after step 22, as long as they are executed after sub-step 211. In some embodiments, steps 23-25 may be executed simultaneously with step 22.

In step 26, in response to receiving the alert event from the driver monitoring unit 12, the processing unit 13 obtains from the image capturing unit 11 a to-be-analyzed image related to the alert event. The to-be-analyzed image is an image captured by the image capturing unit 11 at an occurrence time when the alert event occurred. In the present embodiment, data related to the alert event received by the processing unit 13 may include a timestamp indicating the occurrence time of the alert event. The processing unit 13 may then identify the occurrence time based on the timestamp, and obtain from the image capturing unit 11 the to-be-analyzed image that corresponds to the occurrence time.

In step 27, the processing unit 13 calculates a similarity value indicating similarity between the to-be-analyzed image and the standard image.

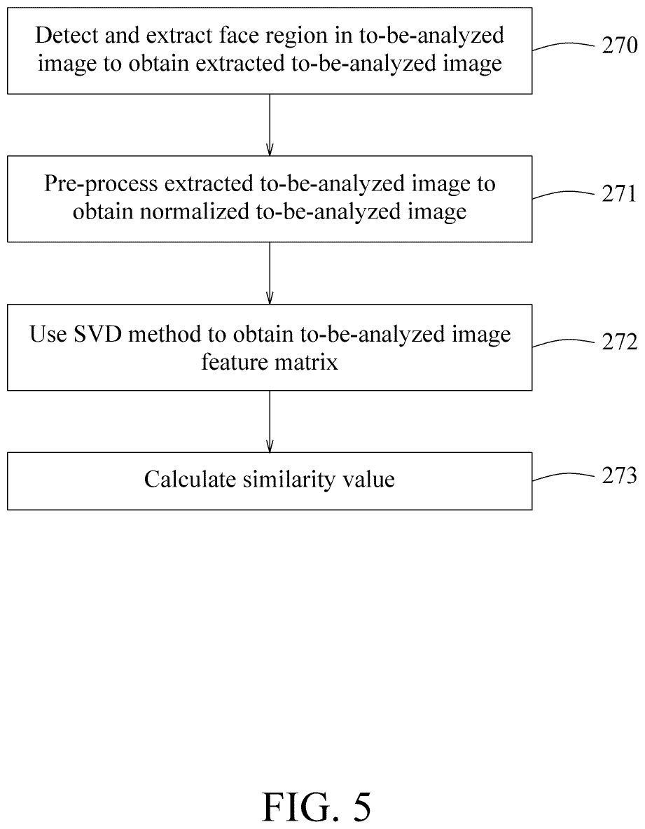

Referring to FIG. 5, step 27 includes sub-steps 270-273 described below.

In sub-step 270, the processing unit 13 detects and extracts a face region in the to-be-analyzed image to obtain an extracted to-be-analyzed image.

In sub-step 271, the processing unit 13 pre-processes the extracted to-be-analyzed image to obtain a normalized to-be-analyzed image.

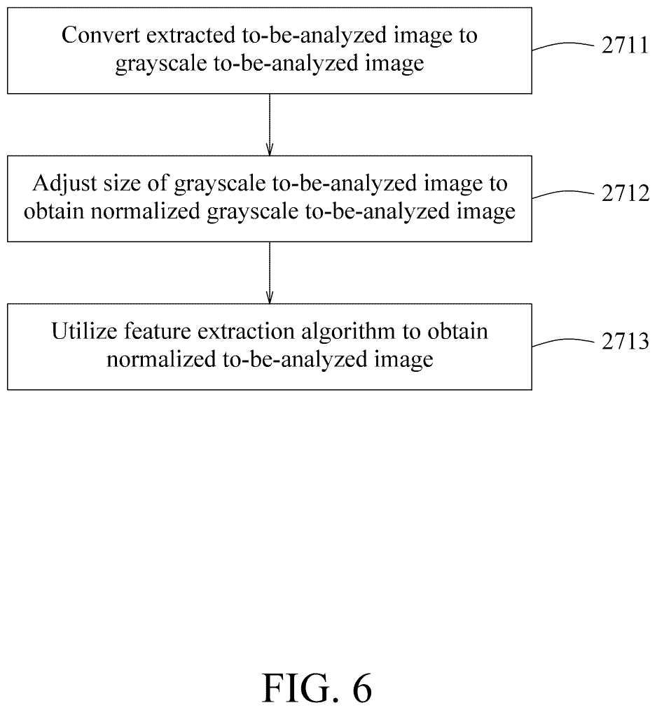

Referring to FIG. 6, sub-step 271 further includes sub-steps 2711-2713 described below.

In sub-step 2711, the processing unit 13 converts the extracted to-be-analyzed image obtained in sub-step 270 to a grayscale to-be-analyzed image.

In sub-step 2712, the processing unit 13 adjusts a size of the grayscale to-be-analyzed image to obtain a normalized grayscale to-be-analyzed image from the grayscale to-be-analyzed image. In the present embodiment, the normalized grayscale to-be-analyzed image has a resolution of 64×96 pixels, but the disclosure is not limited thereto. It should be noted that sub-step 2712 is to obtain the normalized grayscale to-be-analyzed image having a size consistent with the size of the normalized grayscale reference images obtained in sub-step 2112; that is, the normalized grayscale to-be-analyzed image may have other sizes as long as the size of the normalized grayscale to-be-analyzed image is identical to the size of the normalized grayscale reference images.

In sub-step 2713, to reduce the impact of data noise on the normalized grayscale to-be-analyzed image, the processing unit 13 utilizes a feature extraction algorithm to obtain, based on the normalized grayscale to-be-analyzed image, the normalized to-be-analyzed image that includes a plurality of facial features in the normalized grayscale to-be-analyzed image. More specifically, this sub-step is performed to remove irrelevant high-frequency signals in the center of the normalized grayscale to-be-analyzed image, reducing computational load on and ensuring faster processing by the processing unit 13. The feature extraction algorithm used in this sub-step is the same as that used in sub-step 2113, and may be, for example, a 3×3 convolution algorithm, but is not limited thereto.

In sub-step 272, the processing unit 13 uses the SVD method to obtain, based on the normalized to-be-analyzed image, a to-be-analyzed image feature matrix that includes a plurality of singular values of the normalized to-be-analyzed image. That is, the processing unit 13 uses the SVD method to decompose an image data matrix of the normalized to-be-analyzed image into the to-be-analyzed image feature matrix.

In sub-step 273, the processing unit 13 calculates the similarity value between the to-be-analyzed image and the standard image based on the to-be-analyzed image feature matrix and the standard image feature matrix. In the present embodiment, the similarity value is a geometric distance obtained by calculating the Euclidean distance between the to-be-analyzed image feature matrix and the standard image feature matrix, but the disclosure is not limited thereto. That is, a larger Euclidean distance indicates a lower similarity between the to-be-analyzed image feature matrix and the standard image feature matrix (i.e., a lower similarity between the to-be-analyzed image and the standard image).

It is worth noting that in the flow chart shown in FIG. 2, steps 20-25 are executed before step 26. However, in some embodiments, steps 20-25 may be executed after step 26, and the standard image feature matrix and the similarity threshold value may be obtained before sub-step 273. In some other embodiments, steps 26-30 may be executed as a standalone method not executed together with steps 20-25, and vice versa. The order of execution of the steps is not limited to the order disclosed herein.

In step 28, the processing unit 13 determines whether the similarity value calculated in step 27 is greater than the similarity threshold value obtained in step 25 in order to determine whether to control the driver monitoring unit 12 to output an alert signal for alerting the driver. The alert signal may be, for example, an audible warning (e.g., warning sounds) or a visual warning (e.g., flashing lights). In the present embodiment, the processing unit 13 determines whether the similarity value is greater than the similarity threshold value by determining whether the geometric distance is greater than the reference geometric distance threshold value. In a case where the processing unit 13 determines that the geometric distance is greater than the reference geometric distance threshold value, the processing unit 13 determines that the similarity value is not greater than the similarity threshold value (i.e., the determination made in step 28 is negative), and step 29 is performed. In a case where the processing unit 13 determines that the geometric distance is not greater than the reference geometric distance threshold value, the processing unit 13 determines that the similarity value is greater than the similarity threshold value (i.e., the determination made in step 28 is positive), and step 30 is performed.

In step 29, in response to determining that the similarity value is not greater than the similarity threshold value, which means that the alert event was not generated due to a change in posture or position of the driver, the processing unit 13 controls the driver monitoring unit 12 to output the alert signal to alert the driver. In some embodiments, to ensure safety, the driver monitoring unit 12 may further take over operations of the vehicle, for example, by cooperating with a collision avoidance system of the vehicle or automatically activating a braking system of the vehicle.

In some embodiments, the in-vehicle driver monitoring device 1 further includes an accelerometer (G-sensor) 14 electrically connected to the processing unit 13 and configured to measure an acceleration value of the vehicle. In a case where the similarity value is determined to be not greater than the similarity threshold value N number of times consecutively (e.g., three times in a row for three consecutive alert events), with N being an integer greater than 1, in addition to controlling the driver monitoring unit 12 to output the alert signal, the processing unit 13 may further determine whether to reset the quantity of the reference image frames to the original quantity (e.g., 50) and reobtain the standard image (i.e., re-execute the method from step 20) based on a degree of change in the acceleration values continuously measured by the accelerometer from the occurrence time of a first one of the consecutive alert events until the current time when the current alert event occurred. A relatively lower degree of change in the acceleration values indicates stable driving and that the method should be re-executed. A relatively higher change in the acceleration values indicates unstable driving and that the method should not be re-executed. If the acceleration values measured by the accelerometer fluctuate by more than a fluctuation threshold (e.g., 50%) continuously, driving may be considered unstable. For example, if the acceleration value at the occurrence time of the first one of the alert events is 1.2, and the fluctuation in the acceleration value from the occurrence time to the current time exceeds the fluctuation threshold (±50%) (i.e., the acceleration value measured at the current time exceeds 1.8 (1.2×1.5=1.8), or is less than 0.6 (1.2×0.5=0.6)) and exceeds a set number of seconds, this indicates that the driving may be unstable.

In other words, when the alert signal has been outputted multiple times consecutively, the degree of change in the acceleration values measured by the accelerometer may be used to determine whether the driving was stable at the occurrence times of the alert events. If it is determined that the driving was stable, the standard image, which indicates the typical driving posture of the driver, may be re-obtained. Thus, outputting continuous false alert signals due to a change in the driving posture of the driver may be prevented, thereby enhancing the driver's experience.

In step 30, in response to determining that the similarity value is greater than the similarity threshold value, which means that the alert event was generated due to a change in posture or position of the driver, the processing unit 13 controls the driver monitoring unit 12 to not output the alert signal.

In summary, the method of monitoring a driver according to the disclosure uses the standard image feature matrix of the standard image obtained from the reference image frames, and the to-be analyzed image feature matrix of the to-be-analyzed image to calculate the geometric distance, and determines whether to output the alert signal by comparing the geometric distance with the reference geometric distance threshold value, which is calculated by summing up the average and the standard deviation of the reference geometric distances. In this way, the probability of the in-vehicle driver monitoring device misjudging a status of the driver and outputting false alert signals may be reduced, thereby achieving the object of the disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of monitoring a driver to be implemented by an in-vehicle monitoring device that includes an image capturing unit for capturing an image of the driver, a driver monitoring unit for generating an alert event in response to determining that the driver is fatigued or distracted, and a processing unit electrically connected to the image capturing unit and the driver monitoring unit, the method comprising steps, to be implemented by the processing unit, of:
in response to receiving the alert event from the driver monitoring unit, obtaining from the image capturing unit a to-be-analyzed image related to the alert event;
calculating a similarity value indicating similarity between the to-be-analyzed image and a standard image, the standard image indicating a typical driving posture of the driver and being obtained by the processing unit based on a plurality of reference image frames that were captured by the image capturing unit prior to the to-be-analyzed image;
determining whether the similarity value is greater than a similarity threshold value; and
in response to determining that the similarity value is greater than the similarity threshold value, controlling the driver monitoring unit to not output an alert signal related to the alert event.

2. The method as claimed in claim 1, further comprising, prior to the step of calculating the similarity value, steps of:
using an image fusion method to obtain the standard image based on the plurality of reference image frames; and
using a singular value decomposition (SVD) method to obtain, based on the standard image, a standard image feature matrix that includes a plurality of singular values of the standard image.

3. The method as claimed in claim 2, wherein the step of using the image fusion method to obtain the standard image includes sub-steps of:
for each reference image frame of the plurality of reference image frames, detecting and extracting a face region in the reference image frame, so as to obtain a plurality of extracted reference images respectively from the plurality of reference image frames;
pre-processing the plurality of extracted reference images, so as to obtain a plurality of normalized reference images respectively based on the plurality of extracted reference images; and
using the image fusion method to process the plurality of normalized reference images, so as to obtain the standard image.

4. The method as claimed in claim 3, wherein the sub-step of pre-processing the plurality of extracted reference images includes sub-steps of:
converting the plurality of extracted reference images to a plurality of grayscale reference images, respectively;
adjusting a size of each of the plurality of grayscale reference images, so as to obtain a plurality of normalized grayscale reference images respectively from the plurality of grayscale reference images; and
utilizing a feature extraction algorithm to obtain the plurality of normalized reference images respectively based on the plurality of normalized grayscale reference images, each of the plurality of normalized reference images including a plurality of facial features in the corresponding one of the plurality of normalized grayscale reference images.

5. The method as claimed in claim 2, wherein the step of calculating the similarity value includes sub-steps of:
detecting and extracting a face region in the to-be-analyzed image to obtain an extracted to-be-analyzed image;
pre-processing the extracted to-be-analyzed image, so as to obtain a normalized to-be-analyzed image;
using the SVD method to obtain, based on the normalized to-be-analyzed image, a to-be-analyzed image feature matrix that includes a plurality of singular values of the normalized to-be-analyzed image; and
calculating the similarity value based on the to-be-analyzed image feature matrix and the standard image feature matrix.

6. The method as claimed in claim 5, further comprising, prior to the step of determining whether the similarity value is greater than the similarity threshold value, steps of:
for each reference image frame of the plurality of reference image frames, detecting and extracting a face region in the reference image frame, so as to obtain a plurality of extracted reference images respectively from the plurality of reference image frames;
pre-processing the plurality of extracted reference images, so as to obtain a plurality of normalized reference images respectively based on the plurality of extracted reference images;
for each normalized reference image of the plurality of normalized reference images, using the SVD method to obtain, based on the normalized reference image, a reference image feature matrix that includes a plurality of singular values of the normalized reference image, and calculating a reference similarity value based on the standard image feature matrix and the reference image feature matrix; and
obtaining the similarity threshold value based on a plurality of reference similarity values obtained respectively for the plurality of normalized reference images.

7. The method as claimed in claim 5, wherein the sub-step of pre-processing the to-be-analyzed image includes sub-steps of:
converting the extracted to-be-analyzed image to a grayscale to-be-analyzed image;
adjusting a size of the grayscale to-be-analyzed image to obtain a normalized grayscale to-be-analyzed image from the grayscale to-be-analyzed image; and
utilizing a feature extraction algorithm to obtain, based on the normalized grayscale to-be-analyzed image, the normalized to-be-analyzed image that includes a plurality of facial features in the normalized grayscale to-be-analyzed image.

8. The method as claimed in claim 1, further comprising a step of, after the step of determining whether the similarity value is greater than the similarity threshold value:
in response to determining that the similarity value is not greater than the similarity threshold value, controlling the driver monitoring unit to output the alert signal related to the alert event.

9. The method as claimed in claim 8, the in-vehicle driver monitoring device further including an accelerometer electrically connected to the processing unit, the method further comprising steps of, after the step of determining that the similarity value is not greater than the similarity threshold value:
determining whether the similarity value has been determined to be not greater than the similarity threshold value N number of times consecutively, N being an integer greater than 1;
in response to determining that the similarity value has been determined to be not greater than the similarity threshold value N number of times consecutively, determining whether acceleration values continuously measured by the accelerometer fluctuate by more than a fluctuation threshold from an occurrence time of a first alert event until a current time when the alert event occurred; and
in response to determining that the acceleration values fluctuate by more than the fluctuation threshold, re-executing the method.

10. The method as claimed in claim 1, further comprising a step of dynamically obtaining, by the processing unit, the plurality of reference image frames according to one of light intensity, and average brightness distribution and an overall average brightness value of a current driving environment.

11. The method as claimed in claim 10, wherein the step of dynamically obtaining the plurality of reference image frames includes sub-steps of:
in response to determining that an image quality value indicating the light intensity of the current driving environment is lower than an image quality range, determining a quantity of the plurality of reference image frames as a first number, and then obtaining the plurality of reference image frames from the image capturing unit;
in response to determining that the image quality value is within the image quality range, determining a quantity of the plurality of reference image frames as a second number that is less than the first number, and then obtaining the plurality of reference image frames from the image capturing unit; and
in response to determining that the image quality value is above the image quality range, determining a quantity of the plurality of reference image frames as a third number that is less than the first number and the second number, and then obtaining the plurality of reference image frames from the image capturing unit.

12. The method as claimed in claim 1, further comprising steps, to be implemented by the processing unit, of:
obtaining a plurality of initial image frames from the image capturing unit;
obtaining an image quality value based on the plurality of initial image frames;
determining whether the image quality value is above an image quality range;
in response to determining that the image quality value is above the image quality range, making the plurality of initial image frames serve as the plurality of reference image frames; and
in response to determining that the image quality value is not above the image quality range, obtaining a plurality of additional image frames from the image capturing unit, and making the plurality of initial image frames and the plurality of additional image frames together serve as the plurality of reference image frames.

13. The method as claimed in claim 12, wherein the step of obtaining the image quality value includes sub-steps of:
for each initial image frame of the plurality of initial image frames, obtaining a light intensity value for the initial image frame, the light intensity value indicating light intensity of the current driving condition detected at a time at which the initial image frame was captured, and
calculating a percentage of a total quantity of the light intensity values respectively of the plurality of initial image frames that are within an optimal light intensity range, and making the percentage serve as the image quality value.

14. The method as claimed in claim 12, wherein the step of obtaining the image quality value includes sub-steps of:
for each initial image frame of the plurality of initial image frames,
dividing the initial image frame into a plurality of image regions, and obtaining a plurality of average brightness values respectively of the plurality of image regions,
selecting a reference region from among the plurality of image regions, and making the average brightness value of the reference region serve as a reference brightness value,
for each image region of the plurality of image regions except the reference region, obtaining an absolute value of a difference between the average brightness value of the image region and the reference brightness value,
determining whether a maximum one of the absolute values respectively for the plurality of image regions is greater than a brightness difference threshold value,
obtaining an overall average brightness value based on the average brightness values respectively of the plurality of image regions,
determining whether the overall brightness value is within an average brightness optimal range, and
in response to determining that the maximum one of the absolute values is not greater than the brightness difference threshold value and that the overall brightness value is within the average brightness optimal range, determining that the initial image frame has good quality; and
calculating a percentage of a total quantity of the plurality of initial image frames that are determined to have good quality, and making the percentage serve as the image quality value.
